(19) United States
(12) Patent Application Publication
(10) Pub. No.: US 2004/0244528 A1
(43) Pub. Date: Dec. 9, 2004

(54) Camshaft and method for making same

(76) Inventors: Peter Meusburger, Feldkirch (AT); Oskar Muller, Thuringerberg (AT); Peter Wiesner, Ludesch (AT)

Correspondence Address: NOTARO AND MICHALOS, 100 DUTCH HILL ROAD, SUITE 110, ORANGEBURG, NY, 10962-2100, US

(21) Appl. No.: 10/487,903

(22) PCT Filed: Sep. 9, 2002
(86) PCT No.: PCT/CH02/00491

(30) Foreign Application Priority Data
Sep. 27, 2001 (CH) 1780/01

(51) Int. Cl. F16H 53/00

(52) U.S. Cl. 74/567

(57) ABSTRACT

A camshaft receives cams and camshaft bearings. The chamshaft is rectified in the zones receiving the camshaft bearings such that the diameter of the shaft in the bearing zones is smaller than the diameter of the shaft in the cam receiving zones. Thus, it is possible to mount the cams simply without damaging the bearing zones when the cams are mounted on the shaft, and to provide an economical manufacturing process.

The invention relates to a camshaft for the receiving of cams according to the preamble of claim 1 and a method for the production of a camshaft for the mounting of cams according to the preamble of claim 4.

Camshafts of this type are employed for driving machine parts, in particular for driving parts in internal combustion engines, such as for example for valves. In so-called joined together camshafts, also referred to as built camshafts, control cams are forced onto the camshaft and secured in place at the site provided for this purpose, for example by welding or pressing with the shaft. The control shaft can be comprised of solid material but also of tubular material. Apart from solid material, cams can also be produced of sheet metal, for example by sheet metal forming, as has been disclosed in the laid-open applications DE 196 40 872, DE 100 24 553 and the U.S. Pat. No. 5,201,246.

Apart from the cams forced on the cam shafts, subregions are provided on camshafts, at which the shaft is supported rotatably in sleeve bearing support frames of the cylinder head. High requirements with respect to precision are placed upon the camshaft bearing in order to be able to absorb the forces generated during the rotation of the shaft and to ensure a good lubrication film in the bearing. Specific requirements with respect to precision and roughness are placed upon the surface quality of the shaft in the regions of the bearings. Furthermore, of the cam contours, which determine the lifting curves of the gas control valves, very high requirements are placed upon the surface quality with respect to precision and roughness.

Camshafts are therefore often ground as a whole after they have been assembled. In this process the cams as well as also the bearing sites and possibly additional functional surfaces are ground.

It can be useful for some fabrication methods to grind the shafts completely before the mounting in order to lower the fabrication tolerances or to make the joining process even possible. Here, the regions in which the bearing sites of the camshaft are located can partially also be ground.

However, if the bearing sites are not intended to be worked further after the mounting, highly elaborate efforts are required while handling them in order to avoid scratching the bearing regions.

It is herein necessary to guide the cams over the bearing sites until the intended position has been reached. This process is problematic and can lead to damage of the bearing site surface, which can later impair the correct bearing function or may require reworking. For these reasons the grinding of the bearing sites has also been carried out after the joining, which, however, represents a more elaborate operation in the production.

The invention addresses the problem of eliminating the disadvantages of prior art. It addresses in particular the problem of realizing a camshaft with suitable production method, which makes it possible to generate bearing sites of constant high quality and to accomplish this with a high degree of economy.

The invention solves the problem by the formation of a camshaft according to the characteristics of claim 1 and through a production method according to the characteristics of claim 4. The dependent claims define further advantageous implementations of the camshaft or of the production method.

The problem is solved according to the invention thereby that the camshaft, before the camshaft mounting, is ground in the region of the future bearing sites and specifically such that the sensitive bearing sites have a smaller diameter than the main diameter of the shaft. The bearing sites are herein advantageously ground simultaneously, which means in a single operation. This permits an especially economical production with good and constant quality. A further advantageous simplification results if the shaft is developed as a tube. Thereby further weight and material can be saved.

Due to the approach according to the invention, the hazard of damaging the bearing sites during the mounting of the cams can be drastically reduced. Since their opening corresponds to the larger shaft diameter, when forcing the cams onto the shaft, these can be guided over the bearing sites without damaging them and be secured at the location intended for this purpose. A further advantage comprises that the grinding time is shortened since for the axial position of the bearing the requisite measuring accuracy for the grinding is lower. Furthermore, the additional body recesses necessary until now to be provided laterally of the bearings, are no longer required.

The continuation of the fabrication of the camshaft can subsequently be completed according to one of the conventional known methods. The camshaft and method according to the invention are advantageously suitable for all types of cams. But for the camshaft developed according to the invention, the use of cams of sheet metal material is especially suitable, since thereby a large weight saving becomes possible and an especially economical production of the camshaft overall can be attained. Additionally advantageous is the production of the sheet metal cam from a rod section profiled in cam form, which is cut in length to the width of the cam to be produced and subsequently, for example by welding or pressing, is joined onto the shaft at the location intended for this purpose.

If the cam contours were ground after the mounting process, which is customary within prior art, the inventive method now offers further advantages. On the one hand, the shaft can be held in one or several bearing regions during the grinding operation. This increases the precision of the cam contour and lowers the susceptibility to faults. On the other hand, now only the cam contours and axial bearing surfaces and, if necessary, special surfaces such as the cones for seatings of belt pulleys need to be ground. Thereby the grinding time is shortened in the overall process and the grinding process becomes more robust.

In the following the invention will be described by example with schematic Figures. Therein depict:

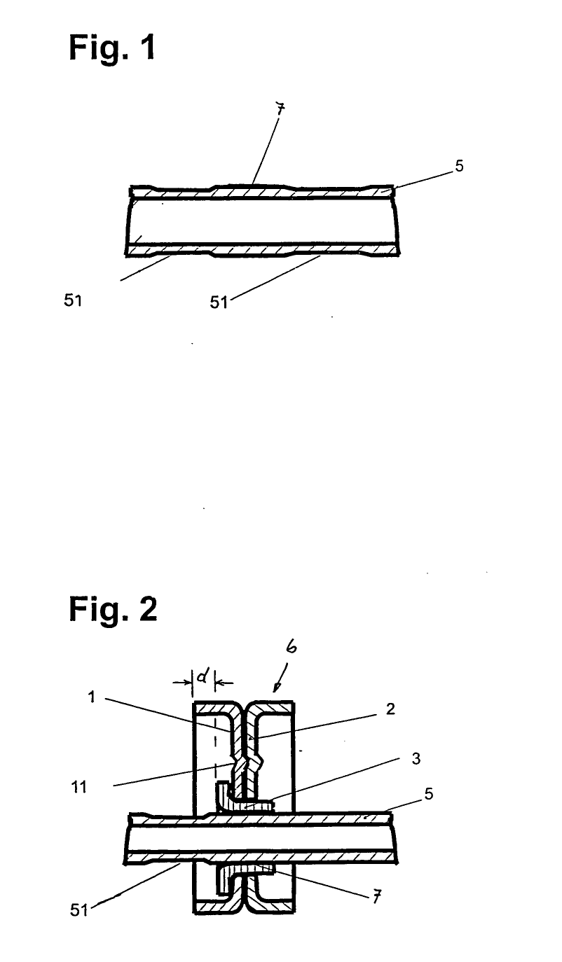

FIG. 1 a camshaft according to the invention in cross section with ground-in bearing sites

FIG. 2 a camshaft with ground-in bearing site and cam disposed adjacently in cross section

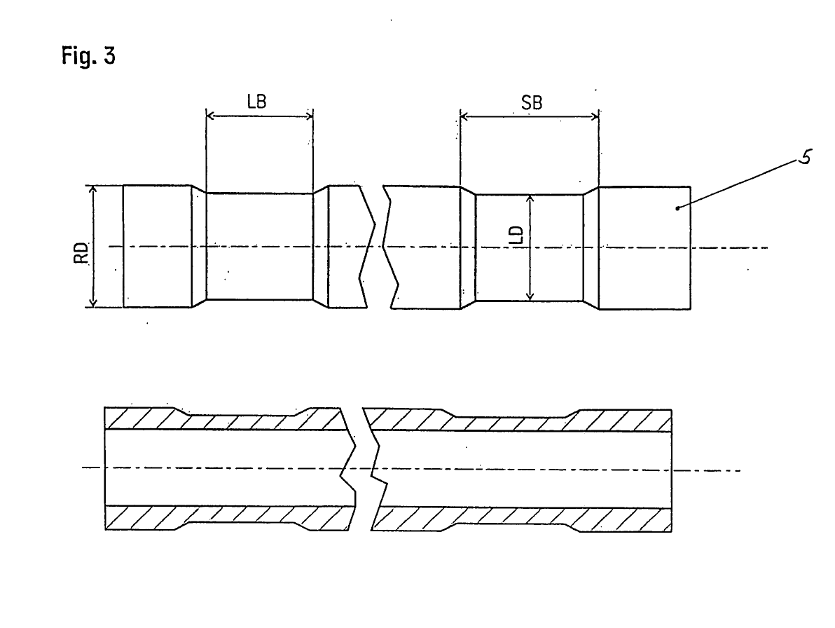

FIG. 3 an enlarged representation of a camshaft with ground-in bearing sites

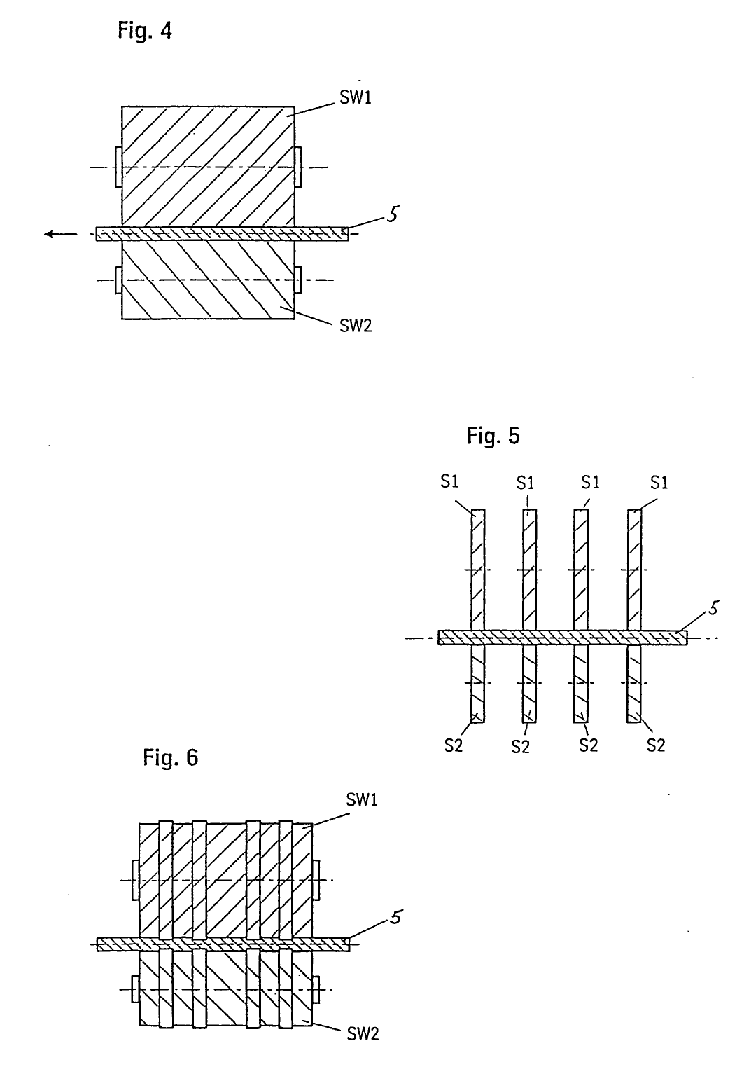

FIG. 4 a configuration for the throughfeed grinding of camshafts

FIG. 5 a configuration for the plunge-cutting of bearing sites with a set of grinding wheels

FIG. 6 a grinding configuration for camshafts for the plunge-cutting with widely profiled grinding wheel

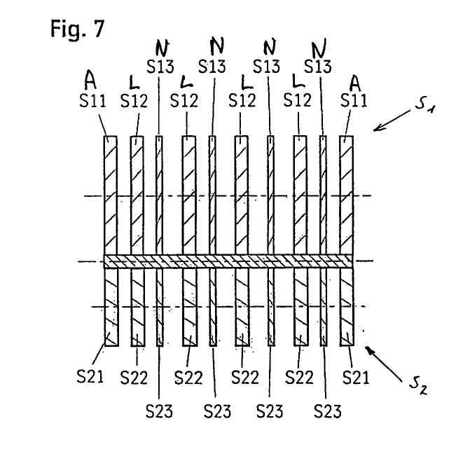

FIG. 7 a grinding configuration with a set of grinding wheels for the grinding of bearing sites, cam setting stations and receptions together on the camshaft

In FIG. 1 is shown a camshaft 5 for receiving cams and for receiving camshaft bearings, which is ground at least in subregions according to the invention on the shaft shell surface to a specific measure of the diameter. Advantageously the camshaft 5 is developed tubularly to save material and weight. At least in regions where the shaft 5 is to be supported later, the surface of this shaft 5 is ground round at the so-called bearing sites 51 and ground to a lower measure of the diameter relative to the original shaft diameter or the larger shaft diameter. The ground-in lesser diameter of shaft 5 should be smaller by a few hundredth to a few tenths mm compared to the shaft diameter. For that reason the cams 6 to be force-fit on the shaft 5 can be forced on without damaging the sensitive bearing sites 51 and secured on the shaft 5 on the location 7 intended for that purpose. Consequently the shaft 5 is ground before the camshaft mounting. In particular the future bearing sites 51 are all ground simultaneously, such that the sensitive bearing site 51 has a somewhat thinner diameter whereby the damage hazard is decreased during the subsequent mounting of the cams 6. A further advantage is that the grinding time can be shortened and the demanded measuring accuracy in the axial direction to the positioning of the bearings becomes decreased. The often conventional additional plunges laterally to the bearings to be disposed in the shaft 5 are no longer required due to the procedure according to the invention. Due to the procedure according to the invention, consequently, the work expenditure can be decreased and the quality of the configuration can be increased.

For camshafts produced in this manner cams 6 are advantageously utilized which are implemented as sheet metal structures, as is shown in FIG. 2 in cross section. Such sheet metal cams are developed to be for example T-form in cross section and are advantageously compounded of a first angular metal sheet part 1 and a second angular metal sheet part 2 to form a T-form cam part, which on the outside has a precise contact surface which, as required, can also be ground to measure and according to the desired curve form. Such metal sheet parts can be produced in simple manner in mass production, for example as pressed metal sheet half-shells. For the correct positioning of the two metal sheet parts with respect to one another, positioning means 11 can be provided on the metal sheet parts 1, 2, which can be generated for example as a knub or a dent by impressing into the metal sheet parts. The metal sheet parts 1, 2 additionally have an opening, developed corresponding to the shaft 5, which make it possible to draw the cam 6 formed therefrom onto the shaft. To fix such a metal sheet cam 6, it is helpful if a sleeve 3 is pressed in between the metal sheet cam 6 and the shaft 5. For this purpose it is helpful if the sleeve 3 is comprised of a softer material and the metal sheet parts 1, 2 of the metal sheet cam 6 of a hardenable material. It is, in addition, helpful for the simple mounting if the sleeve 3 has a collar on one side. For the stationary securement of cam 6 on shaft 5 with the help of sleeve 3 a roller-burnishing 7 is provided in the proximity of the cam setting position on shaft 5, which generates a slight oversize in this region relative to the shaft diameter. Thereby the cam 6 with its opening can be drawn correspondingly simply onto the shaft 5 and pressed in the region of this roller-burnishing 7.

It is understood that other securement methods can also be applied, such as welding and, in particular laser welding. It is also possible to utilize cams, which consist of solid material. The use of metal sheet cams 6 in this respect is far preferred, for one, for reasons of weight, for another for reasons of cost, and, in combination with the shaft ground according to the invention, it is possible to place the bearing extremely close to the cam 6, since, as shown in FIG. 2, the bearing sites 51 can even be ground-in such that bearings can be guided as far as close to the mounted cam 6 or can even slightly undercut the outer contour of the cam 6 as is shown by the spacing designation d in FIG. 2.

As already stated, due to the grinding, according to the invention, of bearing sites 51 on the camshaft 5, no additional plunging operations for positioning and delimiting the bearing sites are necessary, as is customary according to prior art. For example, by contouring of the grinding wheels the appropriate shaping of the end regions of the ground bearing sites 51 can be predetermined. As shown in FIG. 3, it is advantageous to bevel the end regions of the ground-in bearing sites slightly. In FIG. 3 the original diameter of shaft 5 is denoted by RD and the ground-in bearing diameter by LD, with LB denoting the bearing width and SB the wheel run-out width. By the beveling in the margin region of the bearing width LB additionally the canting when forcing on the cams 6 can be prevented.

To produce a completely ground shaft 5, the following procedure can be followed. In a first step shaft 5 is ground with a wide grinding roller SW1 and a regulating wheel SW2 over its entire length to its outer diameter RD, as is shown in FIG. 4 in longitudinal section. In grinding configurations regulating wheels serve for positioning the grinding wheels or for adjusting the grinding body (see Dubbel, page T93, FIG. 49). With the grinding wheels S1 and the regulating wheels S2, which are disposed at the appropriate axial position relative to shaft 5, at which the corresponding bearing sites 51 are to be ground-in, the shaft 5 is subsequently ground to the desired reduced bearing diameter measure LD, as is shown in FIG. 5. As stated earlier, the wheels can be developed in the margin region according to the desired run-out form, for example for a transition from diameter LD to RD, which is developed obliquely.

In FIG. 6 a further preferred variant with a wide profiled grinding wheel SW1 and a wide profiled regulating wheel SW2 is shown in section. This solution permits the simultaneous plunge-grinding of bearing sites and the grinding of the shaft diameter RD jointly.

A further preferred embodiment of the procedure according to the invention comprises that between the bearing sites 51 and the cam setting position 7 the shaft with its outer diameter RD remains unground. For this purpose utilizing sets of grinding wheels S1 and sets of regulating wheels S2, which are disposed alternately spaced apart such that at the appropriate desired position on the shaft, receptions A for the mounting of bearing L for generating bearing sites 51 and cam setting positions N can be ground. The procedural manner is herein highly efficient, since the entire grinding process can be carried out simultaneously, with the bearing sites 51 being ground according to the invention to the smallest shaft diameter.

1. Camshaft for receiving cams (6) and for receiving camshaft bearings with, at least in subregions ground on the shaft shell surface to a specific measure of the diameter, is characterized in that in regions of the provided bearing sites (51) the shaft (5) is ground to a smaller diameter (LD) relative to the greater shaft diameter (RD).

2. Camshaft as claimed in claim 1, characterized in that the ground-in lesser diameter (LD) of the shaft (5) relative to the shaft diameter (RD) is smaller by a few hundredths up to a few tenths mm.

3. Camshaft as claimed in claim 1 [[or 2]], characterized in that the shaft (5) is developed as a tube.

4. Method for the production of a camshaft (5) for the mounting of cams (6) with bearing sites (51), characterized in that the bearing sites (51) are ground-in to a lesser diameter (LD) relative to the shaft diameter (RD) and that subsequently during the mounting of cams (6) these are slid onto the shaft (5) to their location provided for this purpose with the larger shaft diameter (RD) without jamming with the bearing sites (51) or damaging them.

5. Method for the production of a camshaft as claimed in claim 4, characterized in that the grinding process takes place simultaneously for several bearing sites (51) and, if provided, in particular simultaneously with additional grinding-in on the shaft surface.

6. Method for the production of a camshaft as claimed in claim 4, characterized in that the cams (6) are developed as metal sheet parts (1, 2, 3).

7. Method for the production of a camshaft as claimed in claim 4, characterized in that the cams (6) are produced of a tubular rod profile.

8. Method for the production of a camshaft as claimed in claim 4, characterized in that the camshaft (5) is developed tubularly.

9. Method for the production of a camshaft as claimed in claim 4, characterized in that the diameter (LD) of the ground-in bearing site (51) is set to be smaller by a few hundredths to a few tenths mm relative to the greater shaft diameter (RD).

10. Method for the production of a camshaft as claimed in claim 5, characterized in that the cams (6) are produced of a tubular rod profile.

11. Method for the production of a camshaft as claimed in claim 6, characterized in that the cams (6) are produced of a tubular rod profile.

12. Method for the production of a camshaft as claimed in claim 5, characterized in that the camshaft (5) is developed tubularly.

13. Method for the production of a camshaft as claimed in claim 6, characterized in that the camshaft (5) is developed tubularly.

14. Method for the production of a camshaft as claimed in claim 7, characterized in that the camshaft (5) is developed tubularly.

15. Method for the production of a camshaft as claimed in claim 5, characterized in that the diameter (LD) of the ground-in bearing site (51) is set to be smaller by a few hundredths to a few tenths mm relative to the greater shaft diameter (RD).

16. Method for the production of a camshaft as claimed in claim 6, characterized in that the diameter (LD) of the ground-in bearing site (51) is set to be smaller by a few hundredths to a few tenths mm relative to the greater shaft diameter (RD).

17. Method for the production of a camshaft as claimed in claim 7, characterized in that the diameter (LD) of the ground-in bearing site (51) is set to be smaller by a few hundredths to a few tenths mm relative to the greater shaft diameter (RD).

18. Method for the production of a camshaft as claimed in claim 8, characterized in that the diameter (LD) of the ground-in bearing site (51) is set to be smaller by a few hundredths to a few tenths mm relative to the greater shaft diameter (RD).
